(19) United States
(12) Patent Application Publication
(10) Pub. No.: US 2019/0235668 A1
(43) Pub. Date: Aug. 1, 2019

(54) TOUCH SCREEN AND MOBILE TERMINAL

(71) Applicant: Wuhan Chiana Star Optoelectronics Semiconductor Display Technology Co., Ltd., Wuhan (CN)

(72) Inventor: Jian YE, Wuhan (CN)

(21) Appl. No.: 16/009,816

(22) Filed: Jun. 15, 2018

Related U.S. Application Data
(63) Continuation of application No. PCT/CN2018/079122, filed on Mar. 15, 2018.

(30) Foreign Application Priority Data
Jan. 31, 2018 (CN) 201810096392.4

(51) Int. Cl. G06F 3/047; G06F 3/0488

(52) U.S. Cl. CPC G06F 3/047; G06F 3/044; G06F 3/0488

(57) ABSTRACT

The invention provides a touch screen, comprising: a touch area, disposed with a plurality of first and second conductive lines extending along a first and second direction, respectively; the second conductive lines being insulated from and crossing-over the first conductive lines, each of the first or second conductive lines respectively comprising a plurality of first or second sensing electrodes, disposed spaced apart, and a first or second connection bridge connecting every two adjacent first or second sensing electrodes, wherein each first and second conductive line being connected with a first type wire extending to bonding area of the touch screen; a window area being provided in the touch area, cutting off at least one first and/or second conductive line; the cut-off first and/or second conductive lines located on both sides of the window area using electric connection to achieve connection to the bonding area of the touch screen.

### CROSS REFERENCE TO RELATED APPLICATIONS

This application is a continuing application of PCT Patent Application No. PCT/CN2018/079122, entitled “TOUCH SCREEN AND MOBILE TERMINAL”, filed on Mar. 15, 2018, which claims priority to Chinese Patent Application No. CN201810096392.4, filed on Jan. 31, 2018, both of which are hereby incorporated in its entireties by reference.

### BACKGROUND OF THE INVENTION

### 1. Field of the Invention

The present invention relates to the field of display and, in particular, to the field of a touch screen and mobile terminal.

### 2. The Related Arts

The touch screen, with the advantages of fast response, precise positioning, supporting multi-touch control, and long lifespan, is widely used in the field of mobile terminal. For the comfortable use, the substrate of the touch screen is enlarged and the resolution is improved. FIG. 1 shows a schematic view of a structure of a conventional touch screen. As shown in FIG. 1, the touch screen 1′ comprises a touch area 10′, with the two sides of the touch area 10′ as wiring areas 15′, the lower side as bonding area 13′, and the upper side disposed with a window area 14′ for installing camera, speaker hole, infra-red sensing hole, and so on. In the conventional structure, the area above the window area 14′ cannot be disposed with touch control function.

As the technology develops, the trend moves towards the full-screen design, wherein the expectation is to allow for touch control around the window area, such as, above the camera; however, because of the window area cutting off the pattern of the vertical or horizontal touch electrode channel, the remaining pattern for the sensing electrodes is incomplete and unable to connect with the bonding area, thus, unable to achieve touch control function.

### SUMMARY OF THE INVENTION

The primary object of the present invention is to provide touch screen and mobile terminal, able to realize the touch control function around the window area of the touch screen.

To solve the above technical issue, the present invention provides a touch screen, which comprises: a touch area, disposed with a plurality of first conductive lines extending along a first direction and a plurality of second conductive lines extending along a second direction; the second conductive lines being insulated from and crossing-over the first conductive lines, each of the first conductive lines comprising a plurality of first sensing electrodes, disposed spaced apart, and a first connection bridge connecting every two adjacent first sensing electrodes, and each of the second conductive lines comprising a plurality of second sensing electrodes, disposed spaced apart, and a second connecting bridge connecting every two adjacent second sensing electrodes, wherein each first conductive line and each second conductive line being connected with a first type wire extending to bonding area of the touch screen;

a window area being provided in the touch area; the window area cutting off at least one first conductive line or/and at least one second conductive line;

the cut-off first conductive lines or/and second conductive lines located on both sides of the window area using electric connection to achieve connection to the bonding area of the touch screen.

According to a preferred embodiment of the present invention, each first conductive line and each second conductive line segmented by the window area are connected by a connection line, and the connection line is disposed along edge of the window area;

wherein one end of at least a portion of the connection line is connected to the first sensing electrode on one side of the window area, and the other end is connected to the first sensing electrode in the same extension direction on the other side of the window area;

one end of at least a portion of the connection line is connected to the second sensing electrode on one side of the window area; and the other end is connected to the second sensing electrode in the same extension direction on the other side of the window area.

According to a preferred embodiment of the present invention, the first sensing electrode or second sensing electrode of cut-off first conductive line or the second conductive line segmented by the window area are connected to the bonding area through a second type wire; one end of each second type wire of is connected to the outermost first sensing electrode or second sensing electrode, and the other end extends to the bonding area.

According to a preferred embodiment of the present invention, each first conductive line segmented by the window area is connected through a connection line; the connection line is disposed along edge of the window area, one end of the connection line is connected to the first sensing electrode on one side of the window area, the other end is connected to the first sensing electrode in the same extension direction on the other side of the window area;

the second sensing electrode of each second conductive line segmented by the window area is connected to the bonding area through a second type wire, and one end of each second type wire is connected to the outermost one of the second sensing electrodes, the other end extends to the bonding area.

According to a preferred embodiment of the present invention, each second conductive line segmented by the window area is connected through a connection line, the connection line is disposed along edge of the window area, one end of the connection line is connected to the second sensing electrode on one side of the window area, the other end is connected to the second sensing electrode in the same extension direction on the other side of the window area;

the first sensing electrode of each first conductive line segmented by the window area is connected to the bonding area through a second type wire, and one end of each second type wire is connected to the outermost one of the first sensing electrodes, the other end extends to the bonding area.

According to a preferred embodiment of the present invention, in a planar view, the first sensing electrode and the second sensing electrode are separate from each other, and the first connection bridge and the second connection bridge overlap each other.

According to a preferred embodiment of the present invention, the first sensing electrode and the second sensing electrode are diamond-shaped, and the sides of the first sensing electrode and the second sensing electrode are parallel to each other.

According to a preferred embodiment of the present invention, the touch screen further comprises an insulation layer; the insulation layer is disposed between the first connection bridge and the second connection bridge; the insulating layer is disposed between the connection line for connecting the first conductive line and the second sensing electrode, and the insulating layer is disposed between the connecting line for connecting the second conductive line and the first sensing electrode.

According to a preferred embodiment of the present invention, the first sensing electrode is one of a transmitting electrode and a receiving electrode, and the second sensing electrode is the other of the transmitting electrode and the receiving electrode.

Correspondingly, the present invention also provides a mobile terminal, which comprises: at least a touch screen, the touch screen comprising: a touch area, disposed with a plurality of first conductive lines extending along a first direction and a plurality of second conductive lines extending along a second direction; the second conductive lines being insulated from and crossing-over the first conductive lines, each of the first conductive lines comprising a plurality of first sensing electrodes, disposed spaced apart, and a first connection bridge connecting every two adjacent first sensing electrodes, and each of the second conductive lines comprising a plurality of second sensing electrodes, disposed spaced apart, and a second connecting bridge connecting every two adjacent second sensing electrodes, wherein each first conductive line and each second conductive line being connected with a first type wire extending to bonding area of the touch screen;

a window area being provided in the touch area, the window area cutting off at least one first conductive line or/and at least one second conductive line:

the cut-off first conductive lines or/and second conductive lines located on both sides of the window area using electric connection to achieve connection to the bonding area of the touch screen.

According to a preferred embodiment of the present invention, each first conductive line and each second conductive line segmented by the window area are connected by a connection line, and the connection line is disposed along edge of the window area;

wherein one end of at least a portion of the connection line is connected to the first sensing electrode on one side of the window area,

and the other end is connected to the first sensing electrode in the same extension direction on the other side of the window area;

one end of at least a portion of the connection line is connected to the second sensing electrode on one side of the window area, and the other end is connected to the second sensing electrode in the same extension direction on the other side of the window area.

According to a preferred embodiment of the present invention, the first sensing electrode or second sensing electrode of cut-off first conductive line or the second conductive line segmented by the window area are connected to the bonding area through a second type wire; one end of each second type wire of is connected to the outermost first sensing electrode or second sensing electrode, and the other end extends to the bonding area.

According to a preferred embodiment of the present invention, each first conductive line segmented by the window area is connected through a connection line, the connection line is disposed along edge of the window area, one end of the connection line is connected to the first sensing electrode on one side of the window area, the other end is connected to the first sensing electrode in the same extension direction on the other side of the window area;

the second sensing electrode of each second conductive line segmented by the window area is connected to the bonding area through a second type wire, and one end of each second type wire is connected to the outermost one of the second sensing electrodes, the other end extends to the bonding area.

According to a preferred embodiment of the present invention, each second conductive line segmented by the window area is connected through a connection line, the connection line is disposed along edge of the window area, one end of the connection line is connected to the second sensing electrode on one side of the window area, the other end is connected to the second sensing electrode in the same extension direction on the other side of the window area;

the first sensing electrode of each first conductive line segmented by the window area is connected to the bonding area through a second type wire, and one end of each second type wire is connected to the outermost one of the first sensing electrodes, the other end extends to the bonding area.

According to a preferred embodiment of the present invention, in a planar view, the first sensing electrode and the second sensing electrode are separate from each other, and the first connection bridge and the second connection bridge overlap each other.

According to a preferred embodiment of the present invention, the first sensing electrode and the second sensing electrode are diamond-shaped, and the sides of the first sensing electrode and the second sensing electrode are parallel to each other.

According to a preferred embodiment of the present invention, the touch screen further comprises an insulation layer; the insulation layer is disposed between the first connection bridge and the second connection bridge; the insulating layer is disposed between the connection line for connecting the first conductive line and the second sensing electrode, and the insulating layer is disposed between the connecting line for connecting the second conductive line and the first sensing electrode.

According to a preferred embodiment of the present invention, the first sensing electrode is one of a transmitting electrode and a receiving electrode, and the second sensing electrode is the other of the transmitting electrode and the receiving electrode.

The embodiments of the present invention provide the following advantages:

the present provides a touch screen and mobile terminal, by providing a touch control pattern around the window area opened in the touch area, and using connection line to connect a channel segmented horizontally or longitudinally, or connecting the sensing electrodes cut off by the window area to the bonding area through a second type wire, so as to form a complete touch control channel and the continuity and integrity of the touch control channel is maintained; thus, the touch control function around the window area is realized to achieve a true full-screen touch control.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view showing the structure of a known touch screen.

FIG. 2 is a schematic view showing the structure of a touch screen according to an embodiment of the present invention.

FIG. 3 is a schematic view showing the touch unit in FIG. 2.

FIG. 4 is a schematic view showing the cross-section along the A-A direction in FIG. 2.

FIG. 5 is a schematic view showing the structure of the touch screen according to another embodiment of the present invention.

FIG. 6 is a schematic view showing the structure of the touch screen according to yet another embodiment of the present invention

FIG. 7 is a schematic view showing the structure of the mobile terminal according to the first embodiment of the present invention.

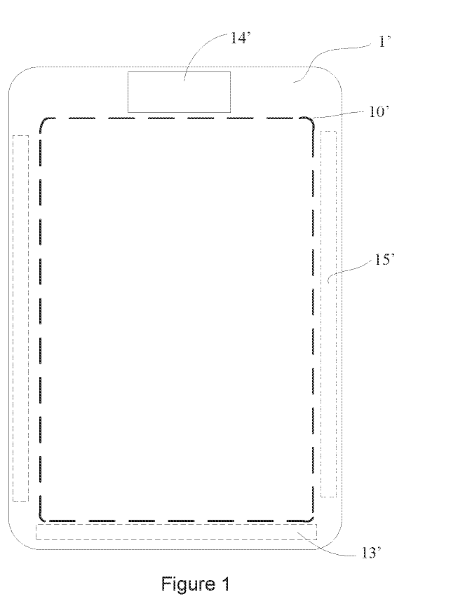

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects and not intended to describe a particular order.

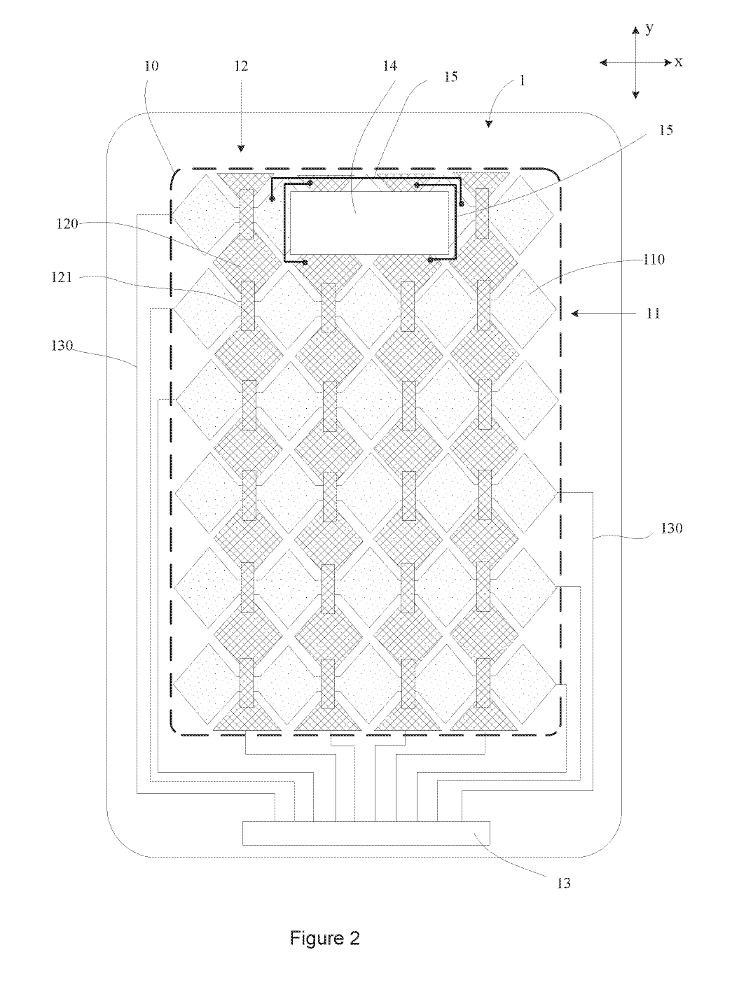

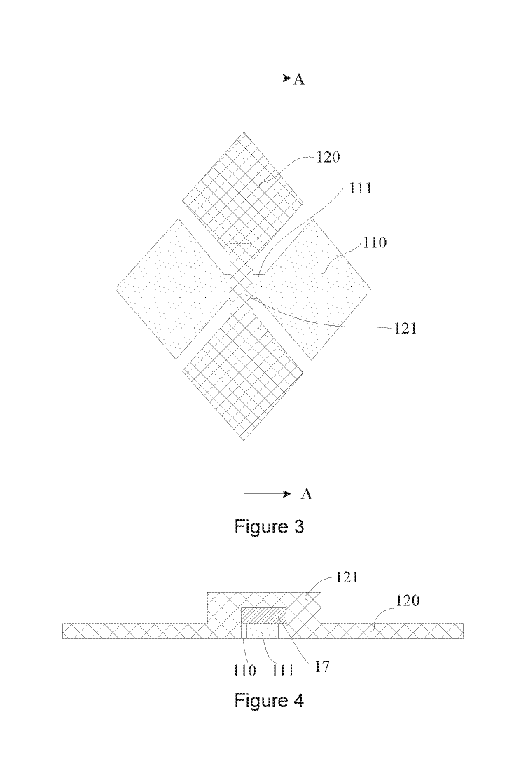

As shown in FIG. 2, the present invention provides a touch screen. Also refer to FIGS. 3, 4. In the present embodiment, the touch screen 1 comprises: a touch area 10, disposed with a plurality of first conductive lines 11 extending along a first direction (such as, x direction) and a plurality of second conductive lines 12 extending along a second direction (such as, y direction); the second conductive lines 12 being insulated from and crossing-over the first conductive lines 11, each of the first conductive lines 11 comprising a plurality of first sensing electrodes 110, disposed spaced apart, and a first connection bridge 111 connecting every two adjacent first sensing electrodes 110, and each of the second conductive lines 12 comprising a plurality of second sensing electrodes 120, disposed spaced apart, and a second connecting bridge 121 connecting every two adjacent second sensing electrodes 120, wherein each first conductive line 11 and each second conductive line 12 being connected with a first type wire 130 extending to bonding area 13 of the touch screen 1; It should be noted that the numbers of first conductive lines 11 and second conductive lines 12 shown in FIG. 2 is for illustrative, not restrictive, purpose.

From a planar view, the first sensing electrode 110 and the second sensing electrode 120 are separate from each other, and the first connection bridge 111 and the second connection bridge 121 overlap each other. It should be noted that the touch screen further comprises an insulation layer 17; the insulation layer 17 is disposed between the first connection bridge 111 and the second connection bridge 121 to realize the insulation between the first connection bridge 111 and the second connection bridge 121. Refer to FIGS. 3 and 4 for specific structure.

In the present embodiment, the touch screen 1 is rectangular. The first sensing electrodes 110 and the second sensing electrodes 120 located at the edges of the rectangular touch screen 1 are triangular, and the remaining first sensing electrodes 110 and second sensing electrodes 120 are diamond-shaped. When viewed from a plane, the first sensing electrodes 110 and the second sensing electrodes are interleaved, and the sides of the first electrodes 110 and the second sensing electrodes are parallel to one another.

A window area 14 is provided in the touch area, the window area 14 cuts off at least one first conductive line 11 or/and at least one second conductive line 12. A segmented first conductive line 11 and two segmented second conductive lines 12 are shown in FIG. 2.

In the present embodiment, the segmented first conductive lines 11 or/and second conductive lines 12 located on both sides of the window area 14 use electric connection to achieve connection to the bonding area 13 of the touch screen 1. Specifically, in the present embodiment, each first conductive line 11 and each second conductive line 12 segmented by the window area 14 are connected by a connection line 15, and the connection line 15 is disposed along edge of the window area 14; wherein the round dots in the figure are the bridging area.

Wherein, one end of at least a portion of the connection line 15 is connected to the first sensing electrode 110 on one side of the window area 14, and the other end is connected to the first sensing electrode 110 in the same extension direction on the other side of the window area 14, as shown in FIG. 2, a horizontal connection line 15.

One end of at least a portion of the connection line 15 is connected to the second sensing electrode 120 on one side of the window area 14, and the other end is connected to the second sensing electrode 120 in the same extension direction on the other side of the window area 14, as shown in FIG. 2, two vertical connection lines 15.

It should be noted that, in wiring the connection lines 15, the insulation must be guaranteed with respect to other sensing electrodes. Specifically, the insulating layer is disposed between the connection line 15 (horizontal connection line) for connecting the first conductive line 11 and the second sensing electrode 120, and the insulating layer is disposed between the connecting line 15 (vertical connection line) for connecting the second conductive line 12 and the first sensing electrode 110. The insulating layer can be disposed as the same layer as the aforementioned insulating layer 17.

The first sensing electrodes 110, the first connection bridges 111, the second sensing electrodes 120, the second connection bridges 121, and the connection lines 15 may be made of the same material, such as, transparent conductive material, indium-tin-oxide (ITO, conductive glass), and so on. No specific restriction is placed on the manufacturing process of the touch screen 1, and different processes can be used. For example, when the connection lines 15 are made of the same material as the first sensing electrodes 110, the first sensing electrodes 110, the second sensing electrodes 120, and the first connection bridges 111 can be formed in the same mask process, and then the second connection bridges 121 and the connection lines 15 are formed. A such, the same mask process can obtain larger-area first sensing electrodes, 110, the second sensing electrodes 120, and the second connection bridges 121 to utilize the material more efficiently and reduce cost.

Wherein, the first sensing electrode 110 is one of a transmitting electrode and a receiving electrode, and the second sensing electrode 120 is the other of the transmitting electrode and the receiving electrode. Specifically, in an embodiment, the first sensing electrode 110 is a transmitting electrode and the second sensing electrode 120 is a receiving electrode; while in another embodiment, he first sensing electrode 110 is a receiving electrode and the second sensing electrode 120 is a transmitting electrode. The transmitting electrode is for inputting a driving signal, and the receiving electrode is for receiving a detection signal. When performing touch detection, the intersection between two conductive lines are checked for mutual capacitance change or self-capacitance change for each conductive line. In other words, the location of the touch is obtained by self-capacitance or mutual-capacitance. For a coordination system with the first direction X and the second direction Y, the touch location can be expressed in the coordination system. Normally, the first direction X and the second direction Y are defined to be perpendicular to each other to simplify the capacitance detection as well as coordination expression. When the touch screen 1 has other shapes, such as, round, irregular or curvy, the first direction and the second direction can be non-perpendicular.

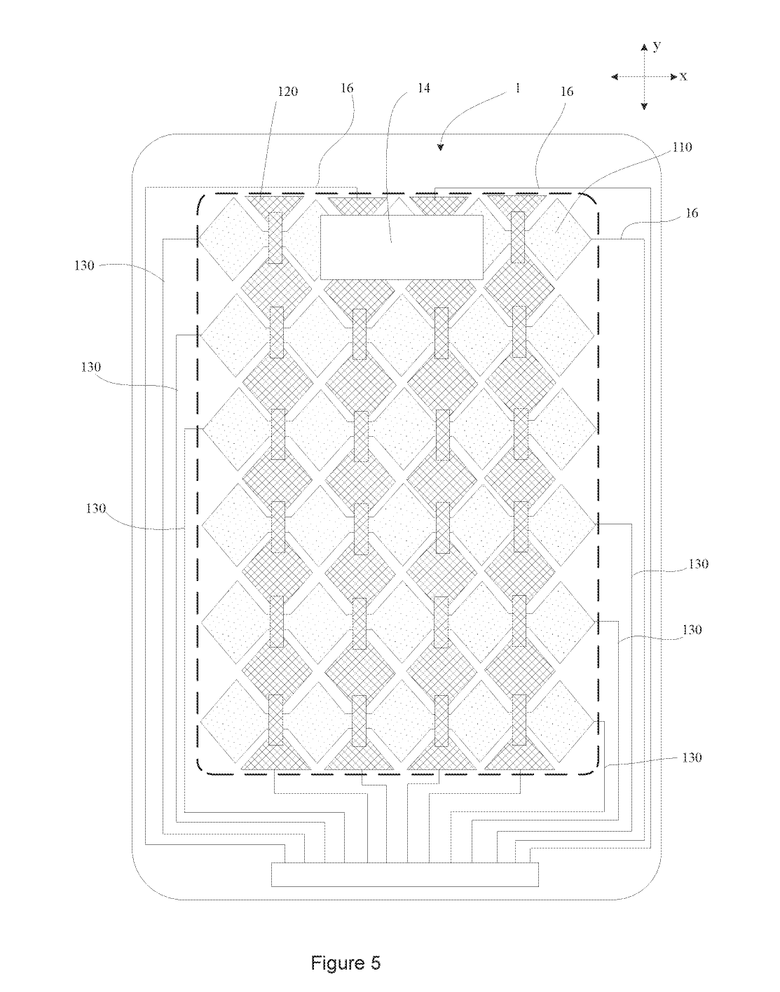

FIG. 5 shows another embodiment of the touch screen of the present invention. This embodiment differs from the embodiment in FIG. 2 in that: the first sensing electrode 110 or second sensing electrode 120 of cut-off first conductive line 11 or the second conductive line 12 segmented by the window area are connected to the bonding area 13 through a second type wire 16; one end of each second type wire 16 of is connected to the outermost first sensing electrode 110 or second sensing electrode 120 (i.e., the topmost two second sensing electrodes 120 and the outermost first sensing electrode 110 at the right side), and the other end extends to the bonding area 13.

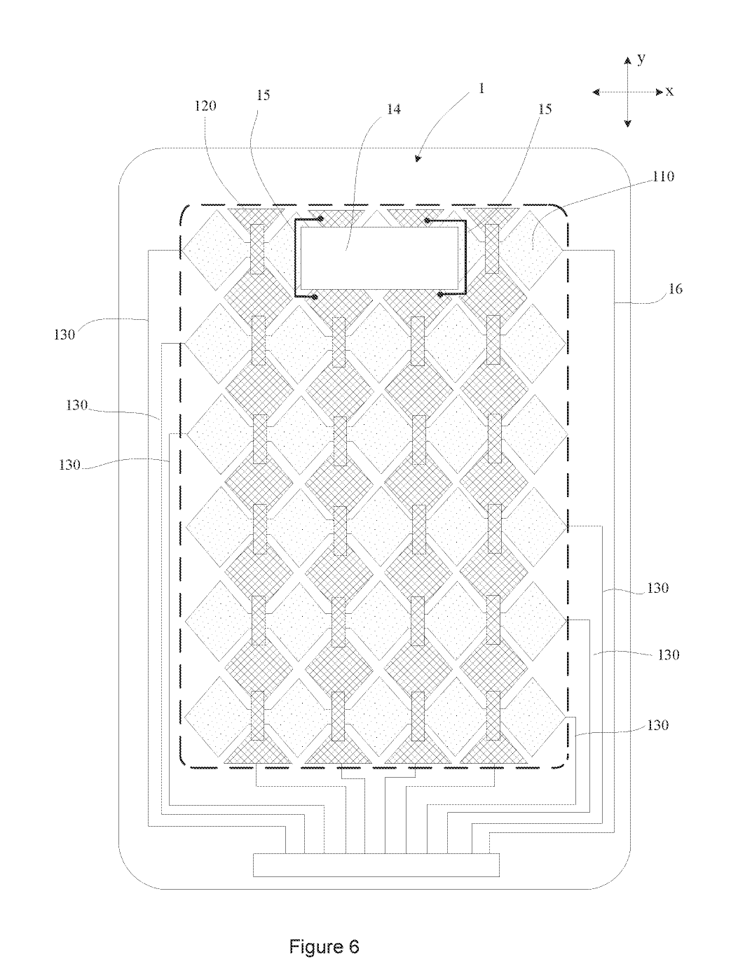

FIG. 6 shows yet another embodiment of the touch screen of the present invention. This embodiment differs from the embodiment in FIG. 2 in that: the conductive lines segmented are connected through connection lines, and the other portion of segmented conductive lines are connected to bonding area through the second type wires.

Specifically, each second conductive line 12 segmented by the window area is connected through a connection line 15, the connection line 15 is disposed along edge of the window area 14, one end of the connection line 15 is connected to the second sensing electrode 120 on one side of the window area 14, the other end is connected to the second sensing electrode 120 in the same extension direction on the other side of the window area 14.

The first sensing electrodes 110 (the first sensing electrode 110 at the right side of the window area 14 as shown in FIG. 6) of each first conductive line 11 segmented by the window area 14 is connected to the bonding area 13 through a second type wire 16, and one end of each second type wire 16 is connected to the outermost one of the first sensing electrodes 110, the other end extends to the bonding area 13.

Similarly, in another embodiment, each first conductive line 11 segmented by the window area 14 is connected through a connection line 15, the connection line 15 is disposed along edge of the window area 14, one end of the connection line 15 is connected to the first sensing electrode 110 on one side of the window area 14, the other end is connected to the first sensing electrode 110 in the same extension direction on the other side of the window area 14;

the second sensing electrode 120 of each second conductive line 12 segmented by the window area 14 is connected to the bonding area 13 through a second type wire 16, and one end of each second type wire 16 is connected to the outermost one of the second sensing electrodes 120, the other end extends to the bonding area 13.

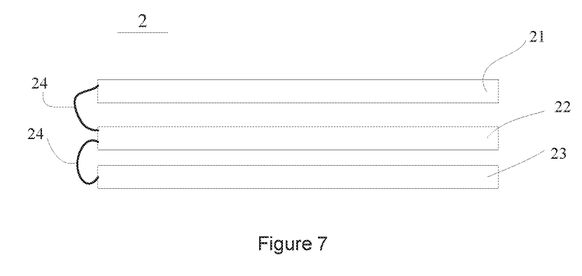

FIG. 7 shows a schematic view of an embodiment of the mobile terminal of the present invention. The embodiment provides a mobile terminal 2, which comprises a touch screen 21, a display panel 22, and a motherboard 23.

The touch screen 21 shares the structures and functions of the touch screen 1 in FIG. 2, 5; or 6. The display panel 22 is a thin film transistor liquid crystal display (TFT-LCD), or active matrix organic light-emitting diode (AMOLED), and the motherboard 23 is to realize the control and computation functions. The touch screen 21, the display panel 22, and the motherboard 23 are connected through FPC flexible cable 24.

The embodiments of the present invention provide the following advantages:

the present provides a touch screen and mobile terminal, by providing a touch control pattern around the window area opened in the touch area; and using connection line to connect a channel segmented horizontally or longitudinally, or connecting the sensing electrodes cut off by the window area to the bonding area through a second type wire, so as to form a complete touch control channel and the continuity and integrity of the touch control channel is maintained; thus, the touch control function around the window area is realized to achieve a true full-screen touch control.

It should be noted that each of the embodiments in this specification is described in a progressive manner; each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A touch screen; comprising: a touch area, disposed with a plurality of first conductive lines extending along a first direction and a plurality of second conductive lines extending along a second direction; the second conductive lines being insulated from and crossing-over the first conductive lines; each of the first conductive lines comprising a plurality of first sensing electrodes, disposed spaced apart, and a first connection bridge connecting every two adjacent first sensing electrodes, and each of the second conductive lines comprising a plurality of second sensing electrodes, disposed spaced apart, and a second connecting bridge connecting every two adjacent second sensing electrodes, wherein each first conductive line and each second conductive line being connected with a first type wire extending to bonding area of the touch screen;
a window area being provided in the touch area, the window area cutting off at least one first conductive line or/and at least one second conductive line;
the cut-off first conductive lines or/and second conductive lines located on both sides of the window area using electric connection to achieve connection to the bonding area of the touch screen.

2. The touch screen as claimed in claim 1, wherein each first conductive line and each second conductive line segmented by the window area are connected by a connection line, and the connection line is disposed along edge of the window area;
wherein one end of at least a portion of the connection line is connected to the first sensing electrode on one side of the window area, and the other end is connected to the first sensing electrode in the same extension direction on the other side of the window area;
one end of at least a portion of the connection line is connected to the second sensing electrode on one side of the window area, and the other end is connected to the second sensing electrode in the same extension direction on the other side of the window area.

3. The touch screen as claimed in claim 1, wherein the first sensing electrode or second sensing electrode of cut-off first conductive line or the second conductive line segmented by the window area are connected to the bonding area through a second type wire; one end of each second type wire of is connected to the outermost first sensing electrode or second sensing electrode, and the other end extends to the bonding area.

4. The touch screen as claimed in claim 1, wherein each first conductive line segmented by the window area is connected through a connection line, the connection line is disposed along edge of the window area, one end of the connection line is connected to the first sensing electrode on one side of the window area, the other end is connected to the first sensing electrode in the same extension direction on the other side of the window area;
the second sensing electrode of each second conductive line segmented by the window area is connected to the bonding area through a second type wire, and one end of each second type wire is connected to the outermost one of the second sensing electrodes, the other end extends to the bonding area.

5. The touch screen as claimed in claim 1, wherein each second conductive line segmented by the window area is connected through a connection line, the connection line is disposed along edge of the window area, one end of the connection line is connected to the second sensing electrode on one side of the window area, the other end is connected to the second sensing electrode in the same extension direction on the other side of the window area;
the first sensing electrode of each first conductive line segmented by the window area is connected to the bonding area through a second type wire, and one end of each second type wire is connected to the outermost one of the first sensing electrodes, the other end extends to the bonding area.

6. The touch screen as claimed in claim 1, wherein in a planar view, the first sensing electrode and the second sensing electrode are separate from each other, and the first connection bridge and the second connection bridge overlap each other.

7. The touch screen as claimed in claim 6, wherein the first sensing electrode and the second sensing electrode are diamond-shaped, and the sides of the first sensing electrode and the second sensing electrode are parallel to each other.

8. The touch screen as claimed in claim 2, wherein the touch screen further comprises an insulation layer; the insulation layer is disposed between the first connection bridge and the second connection bridge; the insulating layer is disposed between the connection line for connecting the first conductive line and the second sensing electrode, and the insulating layer is disposed between the connecting line for connecting the second conductive line and the first sensing electrode.

9. The touch screen as claimed in claim 8, wherein the first sensing electrode is one of a transmitting electrode and a receiving electrode, and the second sensing electrode is the other of the transmitting electrode and the receiving electrode.

10. A mobile terminal, comprising: a touch screen, the touch screen further comprising: a touch area, disposed with a plurality of first conductive lines extending along a first direction and a plurality of second conductive lines extending along a second direction; the second conductive lines being insulated from and crossing-over the first conductive lines, each of the first conductive lines comprising a plurality of first sensing electrodes, disposed spaced apart, and a first connection bridge connecting every two adjacent first sensing electrodes, and each of the second conductive lines comprising a plurality of second sensing electrodes, disposed spaced apart, and a second connecting bridge connecting every two adjacent second sensing electrodes, wherein each first conductive line and each second conductive line being connected with a first type wire extending to bonding area of the touch screen;
a window area being provided in the touch area, the window area cutting off at least one first conductive line or/and at least one second conductive line;
the cut-off first conductive lines or/and second conductive lines located on both sides of the window area using electric connection to achieve connection to the bonding area of the touch screen.

11. The mobile terminal as claimed in claim 10, wherein each first conductive line and each second conductive line segmented by the window area are connected by a connection line, and the connection line is disposed along edge of the window area;
wherein one end of at least a portion of the connection line is connected to the first sensing electrode on one side of the window area, and the other end is connected to the first sensing electrode in the same extension direction on the other side of the window area;
one end of at least a portion of the connection line is connected to the second sensing electrode on one side of the window area, and the other end is connected to the second sensing electrode in the same extension direction on the other side of the window area.

12. The mobile terminal as claimed in claim 10, wherein the first sensing electrode or second sensing electrode of cut-off first conductive line or the second conductive line segmented by the window area are connected to the bonding area through a second type wire; one end of each second type wire of is connected to the outermost first sensing electrode or second sensing electrode, and the other end extends to the bonding area.

13. The mobile terminal as claimed in claim 10, wherein each first conductive line segmented by the window area is connected through a connection line, the connection line is disposed along edge of the window area, one end of the connection line is connected to the first sensing electrode on one side of the window area, the other end is connected to the first sensing electrode in the same extension direction on the other side of the window area;
the second sensing electrode of each second conductive line segmented by the window area is connected to the bonding area through a second type wire, and one end of each second type wire is connected to the outermost one of the second sensing electrodes, the other end extends to the bonding area.

14. The mobile terminal as claimed in claim 10, wherein each second conductive line segmented by the window area is connected through a connection line, the connection line is disposed along edge of the window area, one end of the connection line is connected to the second sensing electrode on one side of the window area, the other end is connected to the second sensing electrode in the same extension direction on the other side of the window area;
the first sensing electrode of each first conductive line segmented by the window area is connected to the bonding area through a second type wire, and one end of each second type wire is connected to the outermost one of the first sensing electrodes, the other end extends to the bonding area.

15. The mobile terminal as claimed in claim 10, wherein in a planar view, the first sensing electrode and the second sensing electrode are separate from each other, and the first connection bridge and the second connection bridge overlap each other.

16. The mobile terminal as claimed in claim 15, wherein the first sensing electrode and the second sensing electrode are diamond-shaped, and the sides of the first sensing electrode and the second sensing electrode are parallel to each other.

17. The mobile terminal as claimed in claim 14, wherein the touch screen further comprises an insulation layer; the insulation layer is disposed between the first connection bridge and the second connection bridge; the insulating layer is disposed between the connection line for connecting the first conductive line and the second sensing electrode, and the insulating layer is disposed between the connecting line for connecting the second conductive line and the first sensing electrode.

18. The mobile terminal as claimed in claim 17, wherein the first sensing electrode is one of a transmitting electrode and a receiving electrode, and the second sensing electrode is the other of the transmitting electrode and the receiving electrode.
